(19) United States
(12) Patent Application Publication
(10) Pub. No.: US 2022/0191449 A1
(43) Pub. Date: Jun. 16, 2022

(54) IMAGE PROCESSING DEVICE, IMAGE CAPTURING DEVICE, MOBILE BODY, AND IMAGE PROCESSING METHOD

(71) Applicant: KYOCERA Corporation, Kyoto (JP)

(72) Inventor: Yuya MATSUBARA, Yokohama-shi, Kanagawa (JP)

(73) Assignee: KYOCERA Corporation, Kyoto (JP)

(21) Appl. No.: 17/442,964

(22) PCT Filed: Mar. 3, 2020
(86) PCT No.: PCT/JP2020/008960

§ 371 Date: Sep. 24, 2021

(30) Foreign Application Priority Data
Mar. 27, 2019 (JP) 2019-060152

(51) Int. Cl. H04N 9/73; G06V 20/56; G06V 10/56; G06V 10/60; H04N 9/77; B60R 1/22; G01C 21/36

(52) U.S. Cl. CPC H04N 9/735; G06V 20/588; G06V 10/56; G01C 21/367; H04N 9/77; B60R 1/22; G06V 10/60

(57) ABSTRACT

An image processing device includes an input interface and at least one processor. The input interface is configured to acquire an image obtained by image-capturing a surrounding region of a mobile body. The computation unit is configured to process the image obtained by image-capturing the surrounding region. The computation unit is configured to execute first processing of detecting, from the image, a region in which the mobile body is movable, and second processing of calculating an adjustment parameter for adjusting the image on the basis of the region in which the mobile body is movable.

### CROSS-REFERENCE TO RELATED APPLICATIONS

The present application claims priority from Japanese Patent Application No. 2019-060152 filed on Mar. 27, 2019, the entire disclosure of which is hereby incorporated by reference.

### TECHNICAL FIELD

The present disclosure relates to an image processing device, an image capturing device, a mobile body, and an image processing method.

### BACKGROUND ART

In recent years, mobile bodies such as automobiles have been equipped with many image capturing devices. For example, an image capturing device is used for displaying, to a driver of a vehicle, a situation around the vehicle that is difficult for the driver to directly view. An image capturing device is also used in driving assistance for recognizing a person around a vehicle, an obstacle such as another vehicle, a lane on a road, and the like, and performing an operation of warning a driver to avoid a vehicle crash, auto brake control, accelerator control for autocruise control, and the like.

An image capturing device typically has a function of automatically adjusting a captured image to reproduce a natural image. The adjustment that is automatically performed includes color adjustment including auto white balance, and luminance adjustment including auto exposure (AE). An image capturing device used in a vehicle typically captures an image including a road and the sky. However, if part of the image includes the sky and the white balance is adjusted on the basis of a blue of the sky, a subject may have a red or yellow tinge and color reproducibility may decrease. Thus, a setting method for not including the sky in a light measurement range for auto white balance has been proposed (see, for example, PTL 1).

### CITATION LIST

### Patent Literature

PTL 1: 2016-225860

### SUMMARY OF INVENTION

An image processing device of the present disclosure includes an input interface and at least one processor. The input interface is configured to acquire an image obtained by image-capturing a surrounding region of a mobile body. The at least one processor is configured to process the image. The at least one processor is configured to execute first processing of detecting, from the image, a region in which the mobile body is movable, and second processing of calculating an adjustment parameter for adjusting the image on the basis of the region in which the mobile body is movable.

An image capturing device of the present disclosure is an image capturing device that is to be mounted in a mobile body and includes an optical system, an image capturing element, and at least one processor. The image capturing element is configured to capture an image of a surrounding region formed by the optical system. The at least one processor is configured to process the image. The at least one processor is configured to execute first processing of detecting, from the image, a region in which the mobile body is movable, and second processing of calculating an adjustment parameter for adjusting the image on the basis of the region in which the mobile body is movable.

A mobile body of the present disclosure includes an image capturing device. The image capturing device includes an optical system, an image capturing element, and at least one processor. The image capturing element is configured to capture an image of a surrounding region formed by the optical system. The at least one processor is configured to process the image. The at least one processor is configured to execute first processing of detecting, from the image, a region in which the mobile body is movable, and second processing of calculating an adjustment parameter for adjusting the image on the basis of the region in which the mobile body is movable.

An image processing method of the present disclosure includes acquiring an image obtained by image-capturing a surrounding region of a mobile body, and detecting, from the image, a region in which the mobile body is movable. The image capturing method includes calculating an adjustment parameter for adjusting the image on the basis of the region in which the mobile body is movable. The image capturing method further includes generating a display image by adjusting the image on the basis of the adjustment parameter.

### BRIEF DESCRIPTION OF DRAWINGS

FIG. 1 is a diagram illustrating a vehicle including an image capturing device mounted therein according to one embodiment of the present disclosure.

FIG. 2 is a block diagram illustrating a schematic configuration of the image capturing device according to one embodiment.

FIG. 3 is a diagram illustrating an example of a schematic configuration of a computation unit in FIG. 2.

FIG. 4 is a diagram illustrating an example of an image obtained by image-capturing a surrounding region of a mobile body.

FIG. 5 is a conceptual diagram of free space detection based on the image illustrated in FIG. 4.

FIG. 6 is a flowchart illustrating an example of a procedure of a process performed by an image processing device.

### DESCRIPTION OF EMBODIMENTS

An image processing device, an image capturing device, a vehicle including these devices mounted therein, and an image processing method executed by these devices according to an embodiment of the present disclosure described below are capable of performing image adjustment that is stable and insusceptible to an imaging environment.

Hereinafter, one of a plurality of embodiments of the present disclosure will be described with reference to the drawings.

### (Disposition in Mobile Body)

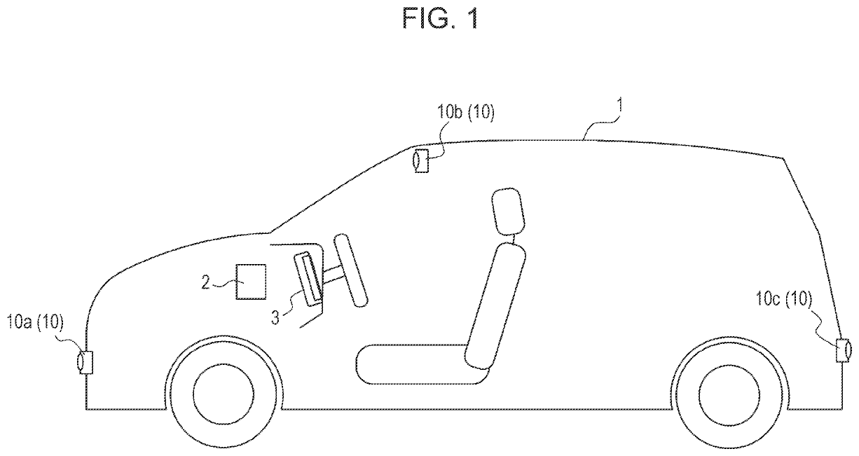

An image capturing device 10 of one embodiment of the present disclosure is mounted in a mobile body. FIG. 1 is a diagram illustrating a mount position of the image capturing device 10 in a vehicle 1 as an example of a mobile body. The image capturing device 10 mounted in the vehicle 1 can be called a vehicle-mounted camera. The image capturing device 10 can be installed in various places of the vehicle 1. For example, an image capturing device 10a serves as a forward monitoring camera when the vehicle 1 travels, and can be disposed at a front bumper or the vicinity thereof. An image capturing device 10b for forward monitoring can be disposed near an inner rearview mirror in a cabin of the vehicle 1. An image capturing device 10c can be installed in a rear portion of the vehicle 1 for rearward monitoring of the vehicle 1. The image capturing device 10 is not limited to those described above, and includes image capturing devices 10 installed at various positions, such as a left-side camera for capturing an image of a left rearward side and a right-side camera for capturing an image of a right rearward side.

An image signal of an image captured by the image capturing device 10 can be output to an information processing device 2, a display device 3, or the like in the vehicle 1. The information processing device 2 in the vehicle 1 includes a device that assists a driver in driving on the basis of information acquired from the image. The information processing device 2 includes, for example, a navigation device, a collision mitigation brake device, an adaptive cruise control device, a lane departure warning device, and the like, but is not limited thereto. The display device 3 is capable of receiving an image signal directly from the image capturing device 10 or via the information processing device 2. The display device 3 may be a liquid crystal display (LCD), an organic electro-luminescence (EL) display, or an inorganic EL display, but is not limited thereto. The display device 3 is capable of displaying an image output from the image capturing device 10 in various situations. For example, the display device 3 is capable of displaying, to a driver, an image signal output from the image capturing device 10 that captures an image of a position that is difficult to be viewed from the driver, such as a rear camera.

The “mobile body” in the present disclosure includes a vehicle, a ship, and an aircraft. The “vehicle” in the present disclosure includes an automobile and an industrial vehicle, but is not limited thereto and may include a railroad vehicle, a household vehicle, and a fixed-wing aircraft that travels along a runway. The automobile includes a passenger car, a truck, a bus, a two-wheeled vehicle, a trolley bus, and the like, but is not limited thereto and may include another vehicle that travels on a road. The industrial vehicle includes an industrial vehicle for agriculture and an industrial vehicle for construction. The industrial vehicle includes a forklift and a golf cart, but is not limited thereto. The industrial vehicle for agriculture includes a tractor, a cultivator, a transplanter, a binder, a combine harvester, and a mower, but is not limited thereto. The industrial vehicle for construction includes a bulldozer, a scraper, an excavator, a crane truck, a dump car, and a road roller, but is not limited thereto. The vehicle includes a human-powered vehicle. The categories of vehicle are not limited to the above. For example, the automobile may include an industrial vehicle capable of traveling along a road, and the same vehicle may be included in a plurality of categories. The ship in the present disclosure includes Marine Jet, a boat, and a tanker. The aircraft in the present disclosure includes a fixed-wing aircraft and a rotary-wing aircraft. Hereinafter, a description will be given under the assumption that the “mobile body” is a “vehicle”. In the following embodiment, a “vehicle” can be read as a “mobile body”.

### (Configuration of Image Capturing Device)

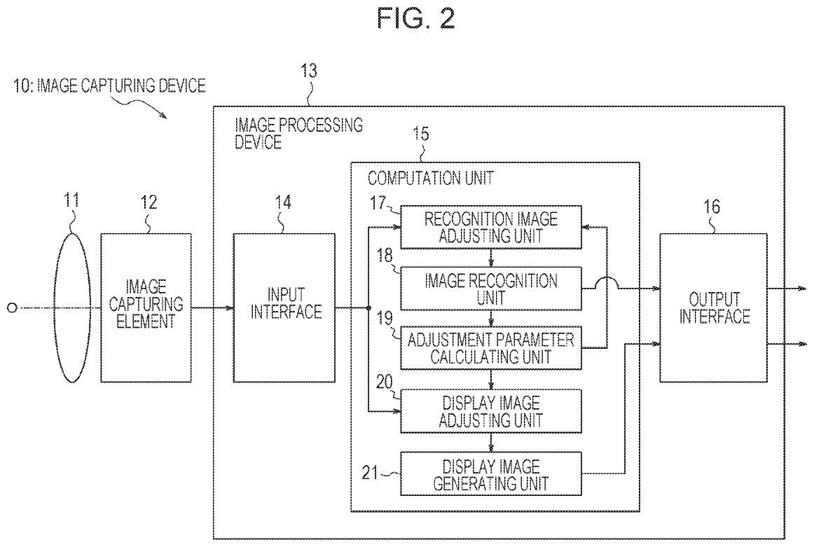

The image capturing device 10 according to one embodiment of the present disclosure includes an optical system 11, an image capturing element 12, and an image processing device 13, as illustrated in FIG. 2. The optical system 11, the image capturing element 12, and the image processing device 13 may be accommodated in one housing. Alternatively, the optical system 11 and the image capturing element 12 may be accommodated in a housing different from a housing accommodating the image processing device 13.

The optical system 11 is configured to form, on an imaging surface of the image capturing element 12, an image of a subject in a surrounding region of the vehicle 1 entered the image capturing device 10. The optical system 11 is constituted by one or more optical elements. The one or more optical elements can include a lens. The one or more optical elements may include other optical elements, such as a mirror, a diaphragm, and an optical filter.

The image capturing element 12 captures an image of a surrounding region of the vehicle 1 formed by the optical system 11. The image capturing element 12 may be any of solid-state image capturing elements including a charge-coupled device (CCD) image sensor and a complementary metal oxide semiconductor (CMOS) image sensor. The image capturing element 12 is capable of performing photoelectric conversion on light received on a light reception surface, thereby converting the image of the surrounding region into an electric signal and outputting the electric signal. The image capturing element 12 is capable of, for example, continuously capturing an image of a surrounding region at a desired frame rate.

### (Configuration of Image Processing Device)

The image processing device 13 is configured to perform various processes on an image output from the image capturing element 12. When the optical system 11 and the image capturing element 12 are accommodated in a housing different from a housing accommodating the image processing device 13, the image processing device 13 includes an input interface 14, a computation unit 15, and an output interface 16. When the optical system 11, the image capturing element 12, and the image processing device 13 are accommodated in one housing, the input interface 14 is not necessary. Hereinafter, a description will be given under the assumption that the optical system 11 and the image capturing element 12 are accommodated in a housing different from a housing accommodating the image processing device 13. The image processing device 13 can be configured as an independent device that acquires an image from the outside.

The input interface 14 is configured to acquire an image from the outside of the image processing device 13. The image processing device 13 included in the image capturing device 10 is configured to acquire an image from the image capturing element 12. The input interface 14 includes a connector compatible with a transmission scheme of an image signal input thereto. For example, the input interface 14 includes a physical connector. The physical connector includes an electric connector compatible with transmission with an electric signal, an optical connector compatible with transmission with an optical signal, and an electromagnetic connector compatible with transmission with an electromagnetic wave. The electric connector includes a connector conforming to IEC 60603, a connector conforming to the USB standard, a connector compatible with an RCA terminal, a connector compatible with an S terminal defined in EIAJ CP-1211A, a connector compatible with a D terminal defined in EIAJ RC-5237, a connector conforming to the HDMI (registered trademark) standard, and a connector compatible with a coaxial cable including BNC. The optical connector includes various connectors conforming to IEC 61754. The input interface 14 can include a wireless communication device. The wireless communication device includes wireless communication devices conforming to Bluetooth (registered trademark) and individual standards including IEEE 802.11. The wireless communication device includes at least one antenna. The input interface 14 performs processing such as protocol processing and demodulation related to reception on an acquired image signal, and transmits the image signal to the computation unit 15.

The computation unit 15 is configured to execute first processing of detecting a region in which the vehicle 1 is movable and second processing of calculating an adjustment parameter for adjusting an image for display (hereinafter referred to as a “display image” as appropriate) on the basis of the region in which the vehicle 1 is movable.

The computation unit 15 includes one or more processors. The “processor” in the present disclosure may include a dedicated processor specializing in specific processing, and a general-purpose processor that reads a specific program to execute a specific function. The dedicated processor may include a digital signal processor (DSP) and an application specific integrated circuit (ASIC). The processor may include a programmable logic device (PLD). The PDL may include a field-programmable gate array (FPGA). The computation unit 15 may be either of a system-on-a-chip (SoC) in which one or more processors cooperate with each other and a system in a package (SiP). The processor may include one or more memories that store programs for various processing operations and information that is being computed. The one or more memories include a volatile memory and a non-volatile memory.

The computation unit 15 is configured to perform various adjustments on an image acquired from the input interface 14 and perform processing of recognizing a subject and a free space included in the image. The “free space” means a region in which a mobile body is movable. When the mobile body including the image capturing device 10 mounted therein is the vehicle 1, the “free space” means a region of a road surface on which the vehicle 1 is capable of traveling (road surface region). The computation unit 15 may control the entire image processing device 13 in addition to the above-described image processing. Furthermore, the computation unit 15 may control the entire image capturing device 10. The computation unit 15 may control the image capturing element 12 to execute continuous image capturing at a certain frame rate. The computation unit 15 may sequentially acquire images continuously captured by the image capturing element 12. The computation unit 15 may output a display image, information acquired through image processing, and so forth as appropriate via the output interface 16 described below. The details of the image processing performed by the computation unit 15 will be described below.

The output interface 16 is configured to output, from the image processing device 13, a display image and other information acquired through image processing. The output interface 16 may perform modulation of information to be transmitted for information transmission and protocol processing. The output interface 16 may be a physical connector and a wireless communication device. In one of a plurality of embodiments, when the mobile body is the vehicle 1, the output interface 16 is capable of connecting to a vehicle network such as a control area network (CAN). The image processing device 13 is connected to the information processing device 2, the display device 3, and so forth of the vehicle via the CAN. Information output via the output interface 16 is used as appropriate by each of the information processing device 2 and the display device 3.

In FIG. 2, the input interface 14 and the output interface 16 are separated from each other, but the configuration is not limited thereto. The input interface 14 and the output interface 16 may be embodied by one communication interface unit.

### (Processing of Computation Unit)

The computation unit 15 is configured to perform image recognition processing and display image generation processing on an acquired image which is obtained by image-capturing a surrounding region of the vehicle 1 (hereinafter referred to as a “surrounding image” as appropriate). The image recognition processing includes detection of a subject and a free space. The display image generation processing includes image adjustment for display on the display device 3 and generation of a display image. Thus, the computation unit 15 can be configured including functional blocks: a recognition image adjusting unit 17; an image recognition unit 18; an adjustment parameter calculating unit 19; a display image adjusting unit 20; and a display image generating unit 21. The recognition image adjusting unit 17 and the image recognition unit 18 are configured to execute image recognition processing. The display image adjusting unit 20 and the display image generating unit 21 are configured to execute display image generation processing. The adjustment parameter calculating unit 19 is configured to calculate a parameter for image adjustment (hereinafter referred to as an adjustment parameter) used in display image generation processing. The adjustment parameter can also be used in image recognition processing.

The individual functional blocks of the computation unit 15 may either be hardware modules or software modules. The operations executed by the individual functional blocks can also be referred to as operations executed by the computation unit 15. The operations executed by the computation unit 15 can also be referred to as operations executed by at least one processor constituting the computation unit 15. The functions of the individual functional blocks may be executed by a plurality of processors in a distributed manner. Alternatively, a single processor may execute the functions of a plurality of functional blocks.

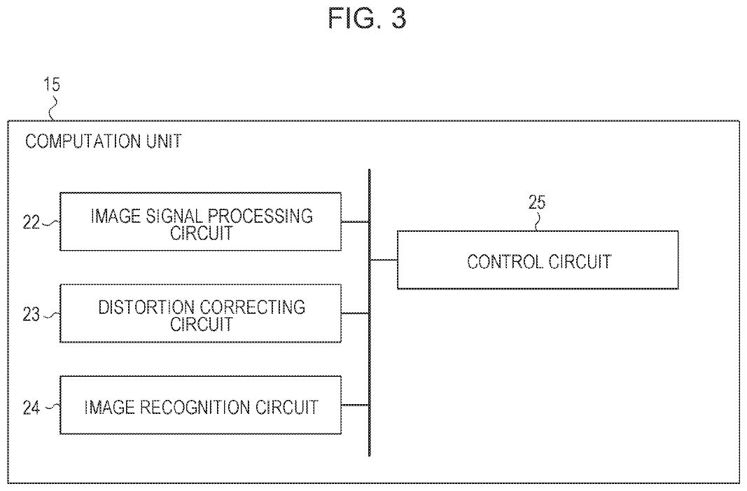

The computation unit 15 may have various hardware configurations. As an example, in the present embodiment, the computation unit 15 includes an image signal processing circuit 22, a distortion correcting circuit 23, an image recognition circuit 24, and a control circuit 25, each of which includes one or more processors, as illustrated in FIG. 3. Each of the image signal processing circuit 22, the distortion correcting circuit 23, the image recognition circuit 24, and the control circuit 25 may include one or more memories. The individual functional blocks of the computation unit 15 may execute processing by using the image signal processing circuit 22, the distortion correcting circuit 23, the image recognition circuit 24, and the control circuit 25.

The image signal processing circuit 22 is configured to execute processing on an image signal of a surrounding image acquired from the image capturing element 12. The processing includes color interpolation, luminance adjustment, color adjustment including white balance adjustment, gamma correction, noise reduction, edge enhancement, and shading. The image signal processing circuit 22 may be implemented by an image signal processor (ISP). The ISP is a processor dedicated to image processing, which performs various image processing operations on an image signal acquired from the image capturing element 12. The ISP is constituted by, for example, an FPGA or the like. The image signal processing circuit 22 is capable of storing an image in a frame buffer and performing pipeline processing so that high-speed processing can be achieved.

The distortion correcting circuit 23 is configured to perform correction of a distortion caused by the optical system 11 and a geometric distortion, on an adjusted image output from the image signal processing circuit 22. The image capturing device 10 mounted in the vehicle 1 often uses a wide-angle lens such as a fish-eye lens, and thus distortion tends to increase in a direction toward a peripheral portion of the image. The distortion correcting circuit 23 is capable of correcting a distortion by using various techniques. For example, the distortion correcting circuit 23 is capable of performing coordinate conversion of converting a pixel position of an image having a distortion to a pixel position of an image in which the distortion has been corrected.

The image recognition circuit 24 is configured to perform image recognition processing on an image that has undergone distortion correction performed by the distortion correcting circuit 23. Specifically, image recognition processing includes detection of a subject and a free space in an image. The free space may be detected as a region of the image excluding regions of the sky and a subject which is an obstacle to movement of the vehicle 1.

The image recognition circuit 24 is configured to perform recognition processing using machine learning including deep learning. The image recognition circuit 24 is capable of detecting a subject, such as a person, a vehicle, or a bicycle, and detecting a free space, by using a model trained by machine learning. Thus, the image recognition circuit 24 can include a dedicated processor for image recognition mounted therein. The processor for image recognition implements, for example, image determination processing using a convolutional neural network used in machine learning. In the field of automobiles, a technique of detecting a free space on the basis of an image acquired from an image capturing device has been intensely studied in recent years. It is known that a free space can be accurately detected as a result of machine learning.

The control circuit 25 includes, for example, a general-purpose microprocessor, and is configured to control the processing of the entire computation unit 15 including the image signal processing circuit 22, the distortion correcting circuit 23, and the image recognition circuit 24. The control circuit 25 may execute processing of the individual functional blocks including the recognition image adjusting unit 17, the image recognition unit 18, the adjustment parameter calculating unit 19, the display image adjusting unit 20, and the display image generating unit 21. The control circuit 25 may control the entire image processing device 13. The control circuit 25 may control the entire image capturing device 10.

Hereinafter, the individual functional blocks including the recognition image adjusting unit 17, the image recognition unit 18, the adjustment parameter calculating unit 19, the display image adjusting unit 20, and the display image generating unit 21 will be described.

The recognition image adjusting unit 17 performs adjustment for image recognition on a surrounding image of the vehicle 1 acquired via the input interface 14. The image signal processing circuit 22 can be used for adjustment for image recognition. The recognition image adjusting unit 17 is capable of adjusting the surrounding image in accordance with an adjustment parameter described below of a preceding frame. The adjustment parameter includes a parameter for adjustment related to at least either of a color and a luminance of the image. The recognition image adjusting unit 17 is capable of performing adjustment of the image for image recognition in accordance with the adjustment parameter. The recognition image adjusting unit 17 may execute correction processing, such as gamma correction, edge enhancement, and shading correction, in accordance with a parameter that is set to increase the detection accuracy for a subject and a free space.

The recognition image adjusting unit 17 is further capable of performing, using the distortion correcting circuit 23, distortion correction on an image output from the image signal processing circuit 22. If distortion correction is performed on the entire image for a distortion or the like resulting from the optical system 11, a dark portion and a portion greatly deformed from a rectangular outer shape as the shape of the image capturing element 12 appear in a peripheral portion of the image. The recognition image adjusting unit 17 is capable of outputting these portions for the following image recognition.

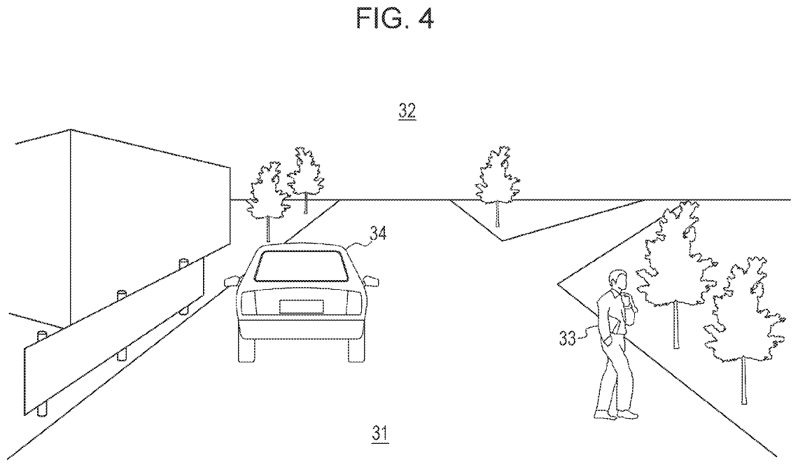

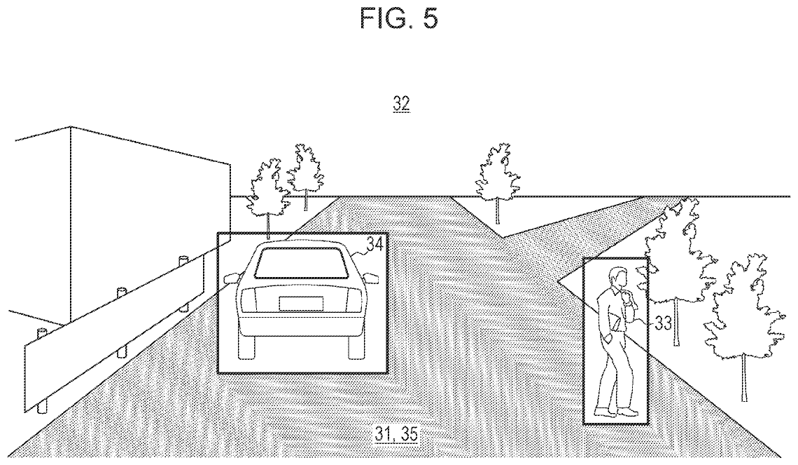

The image recognition unit 18 is configured to execute processing of detecting a subject and a free space (first processing) on a recognition image that is obtained by adjusting the surrounding image for image recognition by the recognition image adjusting unit 17. The processing of the image recognition unit 18 will be described with reference to FIG. 4 and FIG. 5. FIG. 4 illustrates an assumption example of a surrounding image acquired from the image capturing element 12 via the input interface 14. In this case, the image capturing device 10 is a vehicle-mounted camera that monitors ahead of the vehicle 1. The surrounding image may include a road surface 31 of a road, a sky 32, a person 33, another vehicle 34, and other subjects such as a tree, a building, and a guardrail. The road surface 31 is a surface of a road based on a color of a paved road surface (for example, gray). The sky 32 is a blue sky on a sunny day.

The image recognition unit 18 is capable of detecting subjects, such as the person 33 and the other vehicle 34, and a free space by machine learning by using the image recognition circuit 24. FIG. 5 corresponds to FIG. 4 and illustrates a shaded free space 35 detected by the image recognition unit 18. The free space 35 is a region of the entire image excluding the region of the sky 32 and the regions of the person 33 and the other vehicle 34 which are obstacles to movement of the vehicle 1 and the other subjects, such as a tree, a building, and a guardrail. The image recognition circuit 24 is capable of accurately detecting the subjects and the free space 35 included in the surrounding image by image recognition using machine learning such as deep learning. In FIG. 5, subjects such as the person 33 and the other vehicle 34 are illustrated with rectangular frames surrounding these subjects. The free space is a region excluding the regions within these frames. However, the free space can be a region excluding only the region in which subjects are displayed on the image.

The image recognition unit 18 is capable of outputting information acquired as a result of the image recognition processing to the information processing device 2 or the like in the vehicle via the output interface 16. The output information includes, for example, the type, size, and position in the image of a subject. The information of the image recognition result can be used for various applications. For example, the image recognition unit 18 is capable of transmitting information on a detected subject which is an obstacle to movement of the vehicle 1 to the information processing device 2, such as a collision mitigation brake device or an adaptive cruise control device. The information processing device 2 of the vehicle 1 is capable of controlling the vehicle 1 on the basis of the information acquired from the image recognition unit 18.

The adjustment parameter calculating unit 19 is configured to execute processing of calculating an adjustment parameter that is to be used by the display image adjusting unit 20 to adjust a display image (second processing) on the basis of display of the region of a free space. As described above, the free space indicates a road surface. The road surface generally has a known color and luminance with respect to light in a surrounding environment such as the sun. For example, the road surface typically has a gray color of asphalt used for paving. Thus, color adjustment such as white balance adjustment performed using the color of the free space as a reference color reduces an influence of the sky or a subject mainly having a specific color. The color of the free space may be an average of the colors of the entire free space. Alternatively, the color of the free space may be determined by extracting a specific region from the free space. Color adjustment can be performed such that the average of the individual color components of R, G, and B of the free space of the display image has a specific value. The adjustment parameter calculating unit 19 may adjust an average luminance of the display image on the basis of an average luminance of the free space. The adjustment parameter can include at least one of a parameter for luminance adjustment and a parameter for color adjustment.

The adjustment parameter calculating unit 19 is capable of further acquiring information about a light source of light radiated to the free space. The light radiated to the free space includes sunlight, light of a streetlamp, and light emitted by the vehicle 1. The information about the light source includes information indicating a time, weather, a location of movement, and so forth. The adjustment parameter calculating unit 19 may acquire the information about the light source by using a clock included in the image capturing device 10, a sensor included in the image capturing device 10, communication means between the vehicle 1 and another information source, and the like.

The adjustment parameter calculating unit 19 may calculate an adjustment parameter in consideration of the information about the light source. For example, when the free space is irradiated with sunlight in the daytime of a sunny day, the adjustment parameter calculating unit 19 uses the free space to calculate an adjustment parameter. In this case, the brightness of the free space may be lower than an average brightness of the entire image. Thus, the adjustment parameter calculating unit 19 may calculate an adjustment parameter to obtain an appropriate luminance by offsetting the luminance acquired from the free space. That is, the luminance of the entire image is not adjusted such that the luminance of the free space which is a road surface is an average luminance, but the luminance of the entire image is calculated with the luminance of the free space being a reference.

In the nighttime, the adjustment parameter calculating unit 19 is capable of recognizing that the current time is the nighttime, on the basis of a clock, a brightness sensor, a shutter speed of the image capturing device 10, or the like. In the nighttime, the adjustment parameter calculating unit 19 is capable of performing adjustment processing for colors, such as white balance, of a display image under the assumption that the free space is irradiated with red light of a brake lamp of another vehicle. In this case, the adjustment parameter calculating unit 19 sets an offset so that the free space has a red tinge, and calculates an adjustment parameter for adjusting the white balance. Accordingly, it is possible to adjust the display image to have a correct tinge.

Furthermore, the adjustment parameter calculating unit 19 is capable of acquiring, from the navigation device or the like of the vehicle 1, information indicating that the vehicle 1 is traveling in a specific tunnel. In this case, the adjustment parameter calculating unit 19 is capable of adjusting colors, such as white balance, of the display image under the assumption that the road surface as a free space is irradiated with a specific color. The specific color is, for example, an orange color of a low-pressure sodium vapor lamp. In this case, the adjustment parameter calculating unit 19 sets an offset so that the free space has an orange tinge, and calculates an adjustment parameter for adjusting the white balance.

If necessary, the adjustment parameter calculating unit 19 is capable of supplying the adjustment parameter to the recognition image adjusting unit 17 for adjusting a recognition image of the image of the next frame. The adjustment parameter supplied to the recognition image adjusting unit 17 may be different from the adjustment parameter used for adjusting the display image. For example, the adjustment parameter calculating unit 19 is capable of varying the above-described individual offset values to be set for the color or luminance of the free space.

The display image adjusting unit 20 is configured to execute, on a surrounding image acquired from the image capturing element 12 via the input interface 14, adjustment suitable for image display with an adjustment parameter by using the image signal processing circuit 22. Thus, the image signal processing circuit 22 may duplicate the acquired surrounding image to generate a display image in addition to a recognition image. In an existing technique, when an image captured by an image capturing device includes the sky and luminance adjustment is performed on the basis of the brightness of the sky, the entire image may become dark. When white balance adjustment is performed on the basis of a blue color of the sky, the image may have colors different from those of a natural image. In the image capturing device 10 of the present disclosure, a display image is adjusted on the basis of a free space, which is a road surface having a stable luminance and color characteristic, and thus adjustment with high reproducibility can be performed on at least either of luminance and color. Furthermore, the display image adjusting unit 20 may execute other correction processing operations including gamma correction, noise reduction, edge enhancement, and shading correction, to adjust the display image.

The display image adjusting unit 20 is further capable of performing distortion correction on an image output from the image signal processing circuit 22 by using the distortion correcting circuit 23. Distortion correction generates, at a peripheral portion of the image, a dark portion and a portion greatly deformed from a rectangular outer shape as the shape of the image capturing element 12. The recognition image adjusting unit 17 extracts, from the image that has undergone distortion correction, a partial region having a rectangular shape and suitable for display on the display device 3, for example.

The display image generating unit 21 is configured to output, via the output interface 16, the display image that has been adjusted for display by the display image adjusting unit 20. The display image can be displayed on the display device 3 of the vehicle 1. The display image generating unit 21 may perform various processes on the display image and output the display image. For example, the display image generating unit 21 may add a guide line indicating a traveling direction of the vehicle 1 to the display image.

### (Image Processing Method)

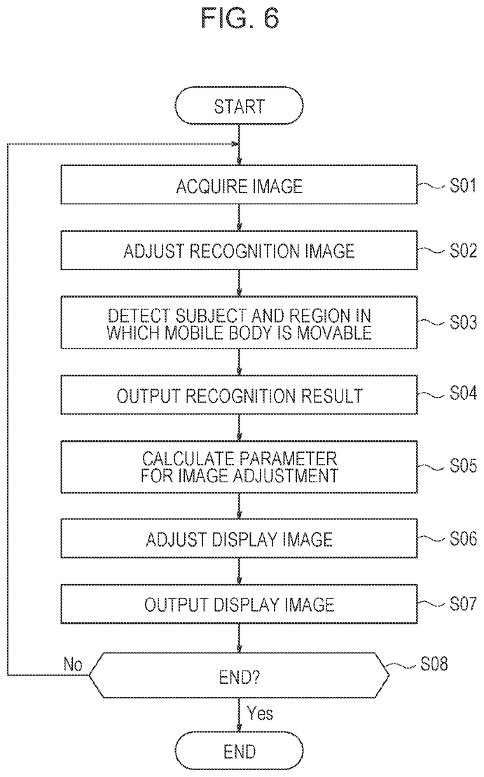

Next, a procedure of image processing performed by the computation unit 15 will be described with reference to FIG. 6. The image processing device 13 may be configured to implement the processing performed by the computation unit 15 described below, by reading a program recorded on a non-transitory computer readable medium. The non-transitory computer readable medium includes a magnetic storage medium, an optical storage medium, a magneto-optical storage medium, and a semiconductor storage medium, and is not limited thereto. The magnetic storage medium includes a magnetic disk, a hard disk, and magnetic tape. The optical storage medium includes optical discs, such as a compact disc (CD), a digital versatile disc (DVD), and a Blu-ray (registered trademark) disc. The semiconductor storage medium includes a read only memory (ROM), an electrically erasable programmable read-only memory (EEPROM), and a flash memory.

First, the computation unit 15 acquires a surrounding image from the image capturing element 12 via the input interface 14 (step S01). The computation unit 15 is capable of temporally continuously acquiring surrounding images. In the following description, among sequential surrounding images acquired by the computation unit 15, images of two certain consecutive frames are regarded as a first image and a second image. The computation unit 15 duplicates the acquired images of the respective frames to generate recognition images and display images, and stores the generated images in the frame buffer.

The recognition image adjusting unit 17 of the computation unit 15 performs adjustment for image recognition on the recognition image obtained by duplicating the first image (step S02). An adjustment parameter can be used for adjustment for image recognition. Here, the adjustment parameter is a parameter calculated by the adjustment parameter calculating unit 19 on the basis of the surrounding image of the frame preceding to the first image. Using of the adjustment parameter for adjustment for image recognition is not essential.

The image recognition unit 18 of the computation unit 15 performs, on the image adjusted for recognition in step S02, detection of a region of a subject which is an obstacle to movement of the vehicle 1 and a region of a free space (step S03). Machine learning including deep learning can be used to detect a free space.

The image recognition unit 18 outputs information acquired in step S03 via the output interface 16 as necessary (step S04). The image recognition unit 18 may output, to the information processing device 2 of the vehicle 1, information indicating the type, position and size in the image of the detected subject, for example. Step S04 is not an essential step.

The adjustment parameter calculating unit 19 of the computation unit 15 calculates an adjustment parameter by using the image of the region of the free space acquired in step S03 (step S05). The adjustment parameter calculating unit 19 updates, with the calculated adjustment parameter, an adjustment parameter to be used to adjust a display image in the image signal processing circuit 22. The adjustment parameter calculated on the basis of the first image can be used to adjust the display image obtained by duplicating the first image.

The adjustment parameter calculating unit 19 is capable of updating, with the calculated adjustment parameter, an adjustment parameter to be used to adjust a recognition image in the image signal processing circuit 22.

The display image adjusting unit 20 of the computation unit 15 performs adjustment for image display on the display image obtained by duplicating the first image by using the adjustment parameter (step S06).

The display image generating unit 21 of the computation unit 15 outputs the display image adjusted by the display image adjusting unit 20 via the output interface 16 (step S07). The display image is displayed on, for example, the display device 3 of the vehicle 1.

The computation unit 15 ends the process in response to receipt of a signal supporting end, for example, in response to power-off of the image processing device 13 or the image capturing device 10 (Yes in step S08). Otherwise (No in step S08), the computation unit 15 repeats the process from step S01 to step S07 on image frames of a surrounding image sequentially acquired from the image capturing element 12 via the input interface 14. In the adjustment of a recognition image obtained by duplicating the second image subsequent to the first image (step S02), the adjustment parameter calculated on the basis of the first image is used.

As described above, according to the present embodiment, a display image is adjusted on the basis of an image of a region which corresponds to a road surface having a stable luminance and color characteristic and in which the vehicle 1 is movable. This makes it possible to perform stable image adjustment insusceptible to an imaging environment. An image that can be acquired by the image processing device 13 of the present embodiment is expected to have both or either of high color reproducibility and high luminance reproducibility.

In the present embodiment, a free space is detected as a region in which the vehicle 1 is movable, by using machine learning including deep learning. This makes it possible to correctly detect the free space other than the regions of the sky and a subject which is an obstacle to movement of the vehicle 1. This makes it possible to further increase the reproducibility of both or either of a luminance and a color of a display image.

Furthermore, in the present embodiment, information about a light source that irradiates a region in which a mobile body is movable (free space) is acquired, and second processing of calculating an adjustment parameter for adjusting a display image is executed in consideration of the information about the light source. Accordingly, an appropriate image suitable for a lighting environment around the vehicle 1 can be displayed.

The embodiment of the present disclosure has been described above on the basis of the drawings and examples. Note that a person skilled in the art could easily make various changes or modifications on the basis of the present disclosure. Thus, note that the changes or modifications are included in the scope of the present disclosure. For example, the functions included in the individual constituent units or the individual steps can be reconfigured without logical inconsistency. A plurality of constituent units or steps can be combined into one or can be divided. A description has been given mainly of a device regarding the embodiment of the present disclosure. The embodiment of the present disclosure may be implemented also as a method including steps executed by the individual constituent units of the device. The embodiment of the present disclosure may be implemented also as a method executed by a processor of a device, a program, or a storage medium storing the program. It is to be understood that the scope of the present disclosure includes the method, program, and storage medium.

For example, in the above embodiment, a vehicle has been described as a mobile body, but the mobile body may be a ship or an aircraft. For example, when the mobile body is a ship, the free space can be a sea surface. In this case, the image processing device is capable of adjusting a display image by using an average color and luminance of the sea surface as a reference.

In the above embodiment, a description has been given that the image recognition unit of the computation unit performs both detection of a subject and detection of a free space. However, detection of a subject and detection of a free space can each be performed independently. Detection of a subject is not essential. The computation unit of the image processing device of the present disclosure may detect only a free space and may calculate an adjustment parameter.

In the above embodiment, an adjustment parameter calculated on the basis of a first image is used to adjust a display image obtained by duplicating the first image, but the present disclosure is not limited thereto. For example, the adjustment parameter calculated on the basis of the first image may be used to adjust a display image obtained by duplicating a second image, which is a subsequent frame. Furthermore, in the above embodiment, free space recognition processing and adjustment parameter calculation processing are performed for each frame. However, free space recognition processing and adjustment parameter calculation processing may be intermittently performed for every several frames. In this case, the calculated adjustment parameter may be used to adjust images of a plurality of frames until the next adjustment parameter is calculated.

### REFERENCE SIGNS LIST

1 vehicle
2 information processing device
3 display device
10 image capturing device
11 optical system
12 image capturing element
13 image processing device
14 input interface
15 computation unit
16 output interface
17 recognition image adjusting unit
18 image recognition unit
19 adjustment parameter generating unit
20 display image adjusting unit
21 display image generating unit
22 image signal processing circuit
23 distortion correcting circuit
24 image recognition circuit
25 control circuit
31 road surface
32 sky
33 person (subject)
34 another vehicle (subject)
25 free space
40 vehicle
41 information processing device
42 display device

1.-11. (canceled)

12. An image processing device comprising:
an input interface that acquires an image obtained by image-capturing a surrounding region of a mobile body; and
at least one processor that processes the image, wherein
the at least one processor includes an adjustment parameter calculating unit that executes
first processing of detecting, from the image, a road on which the mobile body moves, and
second processing of calculating an adjustment parameter for adjusting a color of the entire image on the basis of a color of the road in the image.

13. The image processing device according to claim 12, wherein the adjustment parameter calculating unit calculates an adjustment parameter that causes the color of the road in the image to be a predetermined color, on the basis of information about a light source of light radiated to the road.

14. The image processing device according to claim 13, wherein
the adjustment parameter calculating unit acquires, as the information about the light source of the light radiated to the road, information on weather, and
the second processing calculates an adjustment parameter that is based on the information about the light source.

15. The image processing device according to claim 13, wherein
the adjustment parameter calculating unit acquires, as the information about the light source of the light radiated to the road, information on a time, and
when the time is a time at night, the adjustment parameter calculating unit calculates an adjustment parameter that causes the road in the image to have a red tinge in the second processing.

16. The image processing device according to claim 13, wherein
the adjustment parameter calculating unit acquires, as the information about the light source of the light radiated to the road, a place in which the mobile body is moving, and
the second processing calculates an adjustment parameter that is based on the information about the light source.

17. The image processing device according to claim 16, wherein in response to acquisition, from a navigation device, of information indicating that the mobile body is traveling in a tunnel, the adjustment parameter calculating unit calculates an adjustment parameter that causes the road in the image to have an orange tinge in the second processing.

18. The image processing device according to claim 12, wherein
the processor stores, in a frame buffer, the image as a recognition image and a display image,
the input interface sequentially acquires, as the image, a first image and a second image, and
the processor further executes the first processing by adjusting the recognition image for the second image by using the adjustment parameter calculated by the second processing on the first image, and adjusts the recognition image for the second image by using the adjustment parameter.

19. The image processing device according to claim 12, wherein the second processing calculates the adjustment parameter for adjusting a white balance of the image.

20. An image capturing device that is to be mounted in a mobile body, the image capturing device comprising:
an optical system; and
at least one processor configured to capture an image of a surrounding region formed by the optical system, wherein
the at least one processor includes an adjustment parameter calculating unit that executes
first processing of detecting, from the image, a road on which the mobile body moves, and
second processing of calculating an adjustment parameter for adjusting a color of the entire image on the basis of a color of the road in the image.

21. A mobile body comprising:
an image capturing device including
an optical system, and
at least one processor configured to capture an image of a surrounding region formed by the optical system, wherein
the at least one processor includes an adjustment parameter calculating unit that executes
first processing of detecting, from the image, a road on which the mobile body moves, and
second processing of calculating an adjustment parameter for adjusting a color of the entire image on the basis of a color of the road in the image.

22. An image processing method comprising:
a step of acquiring an image obtained by image-capturing a surrounding region of a mobile body;
a step of executing first processing of detecting, from the image, a road on which the mobile body moves;
a step of executing second processing of calculating an adjustment parameter for adjusting a color of the entire image on the basis of a color of the road in the image; and
generating a display image by adjusting the image on the basis of the adjustment parameter.
